(19) United States
(12) Patent Application Publication
(10) Pub. No.: US 2013/0341283 A1
(43) Pub. Date: Dec. 26, 2013

(54) METHOD FOR PRODUCING A POORLY SOLUBLE CALCIUM-ARSENIC COMPOUND

(71) Applicant: Teppo Riihimäki, Linnavuori (FI)

(72) Inventor: Teppo Riihimäki, Linnavuori (FI)

(73) Assignee: OUTOTEC OYJ, Espoo (FI)

(21) Appl. No.: 14/003,187

(22) PCT Filed: Mar. 7, 2012
(86) PCT No.: PCT/FI12/50222

§ 371 Date: Sep. 4, 2013

(30) Foreign Application Priority Data
Mar. 9, 2011 (FI) 20110085

(51) Int. Cl. C02F 1/52

(52) U.S. Cl. CPC C02F 1/5236
USPC 210/717; 210/721

(57) ABSTRACT

The invention relates to a method for precipitating pentavalent calcium arsenate from an acidic solution, in which arsenic is at least partially in trivalent form. The acidic solution is neutralised before being routed to an arsenic oxidation stage,and a poorly soluble calcium-arsenic compound is precipitated from the solution, in which all the arsenic is pentavalent.

### FIELD OF THE INVENTION

The invention relates to a method for precipitating pentavalent calcium arsenate from an acidic solution, in which arsenic is at least partially in trivalent form. The acidic solution is neutralised before being routed to an arsenic oxidation stage, and a poorly soluble calcium-arsenic compound is precipitated from the solution, in which all the arsenic is pentavalent.

### BACKGROUND OF THE INVENTION

Arsenic occurs naturally in many different formations. Sulphidic minerals often also contain arsenic in addition to the valuable metal itself and therefore arsenic-containing mine waters and other industrial wastewaters are also often generated in connection with the recovery of the valuable metal. Arsenic is also the most important impurity to be removed in connection with the recovery of non-ferrous metals. The use of arsenic has not increased in relation to its recovery, so the majority of arsenic has to be stored in the form of waste. Since arsenic and its compounds are toxic, they must be turned into as poorly soluble a form as possible before being removed from the process. The most poorly soluble arsenic compounds in the neutral pH range are for instance zinc, copper and lead arsenates, but binding arsenic to these valuable metals has not been considered seriously due to the valuable metal content that would remain in the waste. A nowadays widely used arsenic precipitation method is to precipitate arsenic with iron as ferric arsenate, which is quite poorly soluble. In particular the crystalline form of ferric arsenate, scorodite, FeAsO₄.2H₂O, is less soluble than its other form, amorphous ferric arsenate. Another fairly stable compound in which arsenic is precipitated is calcium arsenate.

Typically, arsenic typically occurs in solutions and in solids as either trivalent or pentavalent compounds. Arsenic in its trivalent form is 60 times more toxic than in its pentavalent form. Additionally, it has been found that reject precipitated in trivalent form, for example calcium arsenite, is not as stable as the corresponding pentavalent compound calcium arsenate, nor is it always approved for storage. Nevertheless, for instance up to 30% of mine waters may be in arsenite form, in which case trivalent arsenic has to be oxidised to pentavalent before precipitation.

Arsenic removal from waste waters and mine waters is described for example in U.S. patent publications U.S. Pat. Nos. 5,114,592 and 5,378,366. U.S. patent publication U.S. Pat. No. 5,114,592 describes the precipitation of arsenic as calcium-magnesium arsenate by adding at least one calcium compound and at least one magnesium compound to an arsenic-containing waste solution in the pH range of 2 to 12 and preferably in the range of 9 to 11. The amount of arsenic in the solution is tens of milligrams per litre. Before precipitation, trivalent arsenic is oxidised to pentavalent with a suitable oxidant, such as calcium peroxide CaO₂, magnesium peroxide MgO₂ or hydrogen peroxide H₂O₂ in either an acidic or alkaline range of the pH value. After precipitation of calcium-magnesium arsenate and liquid-solids separation, the remaining arsenic can be further separated from an aqueous solution either by adsorption into activated carbon or by removing the arsenic by ion exchange.

It is essential for the method disclosed in U.S. patent publication U.S. Pat. No. 5,378,366 that the arsenic-containing water to be treated is mainly groundwater or waste water, in which the amount of arsenic is in the order of 2 mg/l (2000 ppm). The temperature of the aqueous solution is first raised to a region of 35 to 100° C. Subsequently the arsenic in the solution is oxidised to pentavalent by using a strong oxidant. After this, a calcium compound is routed to the solution to precipitate the arsenic as calcium arsenate. The precipitation of the calcium arsenate takes place in a very alkaline pH range, at a value of about 11 to 13.

### PURPOSE OF THE INVENTION

The invention relates to a method for removing arsenic from an acidic aqueous solution generated in connection with metallurgical processes, where arsenic is at least partially in trivalent form in the solution and its concentration is many times higher than those presented in the prior art.

### SUMMARY OF THE INVENTION

The invention relates to a method for producing a pentavalent calcium-arsenic compound from an acidic feed solution containing trivalent arsenic, whereby the solution is neutralised with a magnesium compound before routing the solution to an oxidation stage, in which the arsenic is oxidised to pentavalent form by means of a strong oxidant, after which the arsenic is precipitated from the solution with the aid of a calcium compound as a poorly soluble calcium-arsenic compound.

According to one preferred embodiment of the invention, the magnesium compound used for neutralising the feed solution is magnesium hydroxide, Mg(OH)₂.

According to a preferred embodiment of the invention, the calcium compound used for precipitating the arsenic is calcium hydroxide, Ca(OH)₂, or calcium oxide, CaO.

According to a preferred embodiment of the invention, the precipitated calcium-arsenic compound is one or more of the different forms of calcium arsenate.

According to a preferred embodiment of the invention, the strong oxidant is at least one of the following: oxygen and/or sulphur dioxide, ozone or hydrogen peroxide.

According to an embodiment of the invention, gypsum is also removed from the solution along with the precipitated calcium-arsenic compound.

According to a preferred embodiment of the invention, after precipitation and separation of the calcium-arsenic compound, the magnesium in the solution is precipitated by means of a calcium compound as magnesium hydroxide Mg(OH)₂.

According to an embodiment of the invention, one part of the precipitated magnesium hydroxide is fed back to neutralisation (1) of the acidic feed solution containing trivalent arsenic.

According to an embodiment of the invention, a second part of the precipitated magnesium hydroxide is fed to the oxidation stage (2), in which trivalent arsenic is oxidised to pentavalent.

According to an embodiment of the invention, the gypsum in the solution is precipitated from the solution after the arsenic oxidation stage to form a pure gypsum deposit.

### LIST OF DRAWINGS

FIG. 1 presents a flow chart of an embodiment of the method according to the invention.

### DETAILED DESCRIPTION OF THE INVENTION

The purpose of the method according to the invention is to remove arsenic from an acidic aqueous solution generated in connection with metal production. Such an aqueous solution may also be formed in connection with gas scrubbing and it may be for instance an impure solution of sulphuric acid, such as spent acid. The aqueous solution to be treated may contain tens of grams of arsenic per litre and the arsenic should be removed to an extent enabling the solution to be recirculated back to leaching, gas scrubbing or another process step. When the aqueous solution has been used for leaching metals from minerals containing them, it is typical that the aqueous solution contains acid and the pH may be approximately 0 to 1. The arsenic in the solution is at least partially in trivalent form (As³⁺), so it must be oxidised to pentavalent (As⁵⁺) before precipitation.

The method according to the invention is herein described by means of diagram 1. The acidic feed solution should be neutralised in neutralisation stage 1 to a pH value at which no free acid is present in the solution to be routed to oxidation stage 2 of trivalent arsenic. In principle, any neutralising agent, such as CaCO₃, Ca(OH)₂, CaO, MgO, NaOH or KOH, may be used as the acid neutralising agent. However, while developing the method according to the invention, it was found that if neutralisation is performed with the above-mentioned calcium compounds, some of the arsenic tries to react with the calcium as early as in this stage and form calcium arsenite, which is an undesirable compound. At the same time, calcium-based neutralising agents form a gypsum deposit with the sulphuric acid in the solution. In such a case, the final product is a waste deposit containing arsenic both trivalent and pentavalent, as well as gypsum. In addition, it is difficult to control precipitation so as to make a desired amount of trivalent or pentavalent arsenic precipitate into the deposit. On the other hand, if for example potassium or sodium hydroxide (KOH, NaOH) is used as the neutralising agent, precipitation problems can be avoided, but as solutions are recirculated, an excess of sodium and potassium collects in the process, requiring a separate bleed stream to remove them, which in turn increases the overall costs of the process.

When neutralisation of the acid in the solution is carried out in accordance with the invention by using a magnesium compound, for example magnesium hydroxide (Mg(OH)₂), no precipitation of trivalent or pentavalent arsenic occurs as yet in the neutralisation stage. Nor does the magnesium sulphate being formed precipitate out in these conditions but remains in the solution.

H₂SO₄+Mg(OH)₂→MgSO₄+2H₂O (1)

The neutralised solution is routed to oxidation stage 2, where the oxidation of trivalent arsenic to pentavalent is performed by means of known oxidants, for example by using oxygen and sulphur dioxide, ozone or hydrogen peroxide. The pH range of oxidation is not so precise when the above-mentioned strong oxidants are used. Trivalent arsenic is oxidised to pentavalent in accordance with the equation below:

3AsO₂⁻+O₃(g)+3H₂O=3H₂AsO₄⁻ (2)

The pentavalent arsenic (acid) that is formed is a stronger acid than the trivalent one, so the pH of the solution drops in the oxidation process, and the solution is neutralised using for example the magnesium hydroxide-gypsum sediment to be recirculated from a later stage:

3AsO₂⁻+O₃(g)+1.5Mg(OH)₂=3HAsO₄²⁻+1.5Mg²⁺ (3)

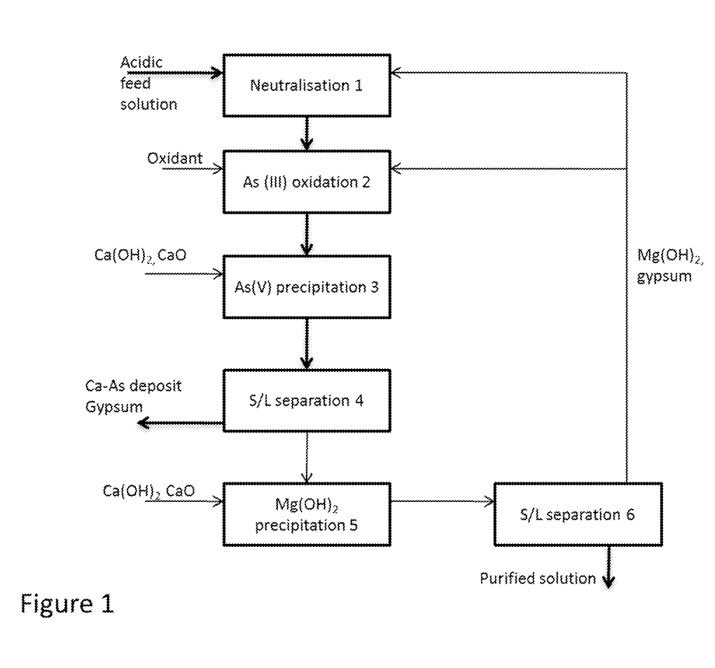

The gypsum in the precipitate, CaSO₄.2H₂O, does not interfere with the neutralisation of the oxidation, because it does not dissolve in these conditions. In this stage, a slurry is formed of the solution containing pentavalent arsenic and the precipitate, which is mainly gypsum. Before the precipitation of arsenic as a calcium-arsenic compound, the gypsum deposit can be separated from the arsenic(V) solution by liquid-solids separation (not shown in detail in the diagram). The gypsum deposit can for example be transferred to a different waste site, and in the following stage a pure calcium arsenate deposit can be made to precipitate. When necessary, since the metals in the solution are in hydroxide form, the remaining arsenic and other metals can first be washed off the precipitated gypsum deposit by using an acid-containing solution. When the feed solution is a solution generated or formed in connection with metal production, the other metals are for example iron, copper, nickel, and zinc. Another alternative, which is presented in FIG. 1 is to omit the liquid-solids separation and precipitate the calcium arsenate along with the gypsum deposit, whereby they end up in the same waste site.

After the arsenic oxidation stage, a calcium compound is fed to the solution, for instance calcium hydroxide, Ca(OH)₂, i.e. slaked lime, or calcium oxide, CaO, i.e. burnt lime, in order to precipitate arsenic from the solution in precipitation stage 3. For precipitation the pH of the solution is adjusted to a range of 6 to 9, in other words to a range in which the magnesium in the solution does not yet begin to precipitate as hydroxide, but a calcium-arsenic compound precipitates. Precipitation occurs at the same temperature as other solution treatment, i.e. generally in the range of 25 to 75° C. Arsenic precipitates from the solution in the various forms of calcium arsenate, and unless gypsum has been separated in an earlier step, it is present in the deposit. The slurry is subjected to solids-liquid separation 4 and the precipitated solids are separated from the solution.

The calcium-arsenic compound precipitates with calcium hydroxide as follows:

H₃AsO₄+2Ca(OH)₂=Ca₂AsO₄OH+3H₂O (4)

The precise form of the precipitated compound depends on the pH value of the precipitation step, and several compounds may be present in the deposit, but they are different forms of calcium arsenate. Since precipitation has to be carried out in a pH range of below 9 in order to avoid the co-precipitation of magnesium, the calcium-arsenic compound being generated is more stable than compounds formed in a higher pH range.

Since, after arsenic removal, the solution still contains dissolved magnesium sulphate generated in neutralisation, magnesium is precipitated from the solution in Mg precipitation stage 5 by means of a calcium compound (calcium hydroxide or oxide) as magnesium hydroxide in a pH range of 9 to 11, preferably in a range of 9 to 10.

MgSO₄+Ca(OH)₂→Mg(OH)₂+CaSO₄ (5)

Since in the Mg precipitation the pH is raised to a value above 9, other metals possibly contained in the solution also precipitate. Only alkali metals, such as sodium or potassium, do not precipitate, so when using alkali-based neutralising agents the alkali concentration in the solution increases due to recirculation and its removal from the process requires a separate treatment stage, as stated above.

The slurry formed is subjected to solids-liquid separation 6, in which an Mg hydroxide precipitate is separated from the solution. A first part of the precipitate is fed back to neutralisation stage 1 of the arsenic-containing aqueous ous solution and a second part to arsenic oxidation stage 2. In these stages, magnesium hydroxide acts as the neutralising agent. The gypsum precipitating along with the Mg hydroxide does not dissolve in the aqueous solution neutralisation conditions, so it does not bring about the precipitation of trivalent arsenic. As stated above, the pentavalent arsenic formed in oxidation is mostly arsenic acid, the formation of which lowers the pH value of the solution, whereupon the magnesium hydroxide functions as the neutralising agent also in this stage.

After liquid-solids separation, the purified aqueous solution, from which the arsenic and magnesium have been removed, can be recirculated without separate purification and removal stages back to the process from which the arsenic-containing solution has been routed to the arsenic oxidation and precipitation process.

Since the neutralisation of the acidic feed solution is carried out by using a magnesium compound, the precipitation of pentavalent arsenic as a calcium-arsenic compound can be controlled, even though the chemical used in the process in the precipitation of the calcium-arsenic compound is calcium-based. Alternatively, separate gypsum and calcium-arsenic deposits can be made in the process for example on account of lower waste costs. The process is economical, because only a calcium compound is used therein as the precipitation chemical.

1. A method for producing a pentavalent calcium-arsenic compound from an acidic feed solution containing trivalent arsenic, whereby the solution is neutralised (1) with a magnesium compound before being routed to an oxidation stage (2), in which the arsenic is oxidised to pentavalent by means of a strong oxidant, after which the arsenic is precipitated (3) from the solution with the aid of a calcium compound as a poorly soluble calcium-arsenic compound.

2. The method according to claim 1, wherein the magnesium compound used for neutralisation is magnesium hydroxide Mg(OH)₂.

3. The method according to claim 1, wherein the calcium compound used for arsenic precipitation is calcium hydroxide, Ca(OH)₂, or calcium oxide, CaO.

4. The method according to claim 1, wherein the precipitated calcium-arsenic compound is one or more of the different forms of calcium arsenate.

5. The method according to claim 1, wherein the strong oxidant is at least one of the following: oxygen and/or sulphur dioxide, ozone or hydrogen peroxide.

6. The method according to claim 1, wherein gypsum is also removed from the solution along with the precipitated calcium-arsenic compound.

7. The method according to claim 1, wherein, after precipitation and separation (4) of the calcium-arsenic compound, the magnesium in the solution is precipitated (5) by means of a calcium compound as magnesium hydroxide Mg(OH)₂.

8. The method according to claim 1, wherein a first part of the precipitated magnesium hydroxide is fed back to the neutralisation (1) of the acidic feed solution containing trivalent arsenic.

9. The method according to claim 1, wherein a second part of the precipitated magnesium hydroxide is fed to the oxidation stage (2), in which trivalent arsenic is oxidised to pentavalent.

10. The method according to claim 1, wherein the gypsum in the solution is precipitated from the solution after the arsenic oxidation stage (2) to form a pure gypsum deposit.
